(19) United States
(12) Patent Application Publication
(10) Pub. No.: US 2011/0118067 A1
(43) Pub. Date: May 19, 2011

(54) Drive with Belt

(76) Inventor: Henry Bronson, Oak Brook, IL (US)

(21) Appl. No.: 12/618,702

(22) Filed: Nov. 13, 2009

(51) Int. Cl. F16H 55/36

(52) U.S. Cl. 474/166

(57) ABSTRACT

Disclosed herein are embodiments of a hub comprising a hub shell provided with a first flange and a second flange, a composite axle that is provided with a plurality of stops, a first end, and a second end, a first end cap and a second end cap, wherein the first end cap is secured to the first end of the composite axle, and the second end cap is secured to the second end of the composite axle.

### FIELD

Embodiments disclosed herein relate to drives and hubs used in human powered vehicles.

### BACKGROUND

A sprocket driven by a metal chain used with a hub employing an over-running clutch are known. In such applications, the hub houses the over-running clutch and hence is fabricated from a metal, often aluminum. However, the over-running clutch and the metal materials associated therewith suffer from a number of drawbacks. For one thing, the over-running clutch creates drag and is a complicated assembly of pawls which are noisy (and hence unsuitable for sensitive military applications). Furthermore, the metal materials used in the chain and the hubs are relatively heavy, thereby requiring more energy to put wheels in motion. Additionally, metal materials are prone to weaken when exposed to the corrosive effects of water and salts, both of which are often encountered on roads and other areas where axles are used.

Consequently, there exists a long felt, but unmet, need to make wheels and wheel components lighter. There also exists a long-felt, but unmet, need to make wheel components last longer by withstanding the corrosive effects of road conditions. The present invention addresses this need by using a belt fabricated from an elastomeric material (such as a polyurethane) and the hub from a plastic material. Elastomeric and plastic materials are lighter than the metal materials currently used. Furthermore, these materials withstand the corrosive effects found where axles are used better than metals do.

Accordingly, the present invention is directed to overcoming these and other problems inherent in prior art drives, hubs, and wheels.

### SUMMARY

The scope of the present invention is defined solely by the appended claims, and is not affected to any degree by the statements within this summary. Disclosed herein are embodiments of an belt with asymmetrical teeth, a plurality of pulleys, and at least one treadle.

### BRIEF DESCRIPTION OF THE DRAWINGS

FIG. 1 is cross-sectional view of a belt constituting a presently preferred embodiment of the present invention;

FIG. 2 is cross-sectional view of the belt shown in FIG. 1, with fibers depicted as circles representing reinforcing material;

FIG. 3 is a cross-sectional view of the belt illustrated in FIG. 1;

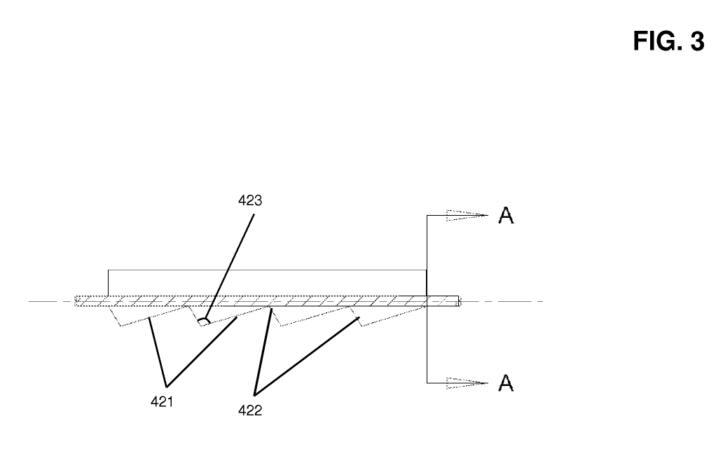

FIG. 4 is a side view of a pulley representing a preferred embodiment of the present invention;

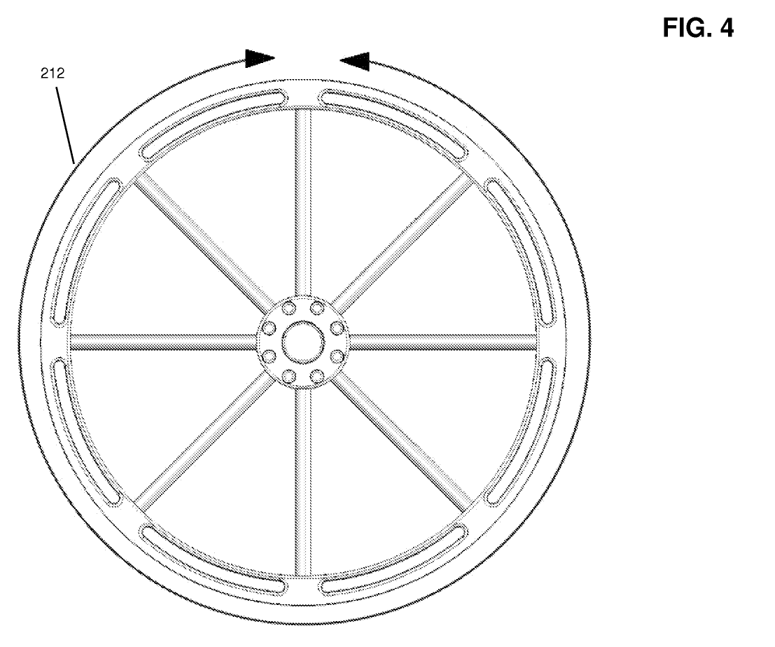

FIG. 5 is a perspective view of a pulley representing a preferred embodiment of the present invention;

FIG. 6 is cross-sectional view of the belt of FIG. 1 and the pulley of FIGS. 4 and 5;

FIG. 7 is a cross-sectional view of the pulley of FIGS. 4 and 5;

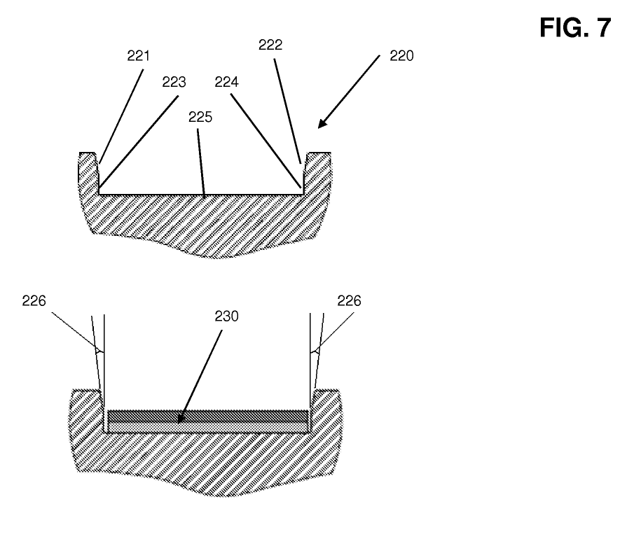

FIG. 8 is a perspective view of a driven pulley representing a preferred embodiment of the present invention;

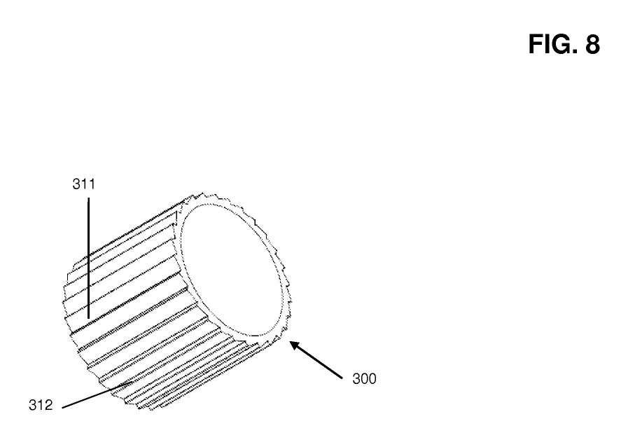

FIG. 9 is a cross-sectional view of the pulley shown in FIG. 8;

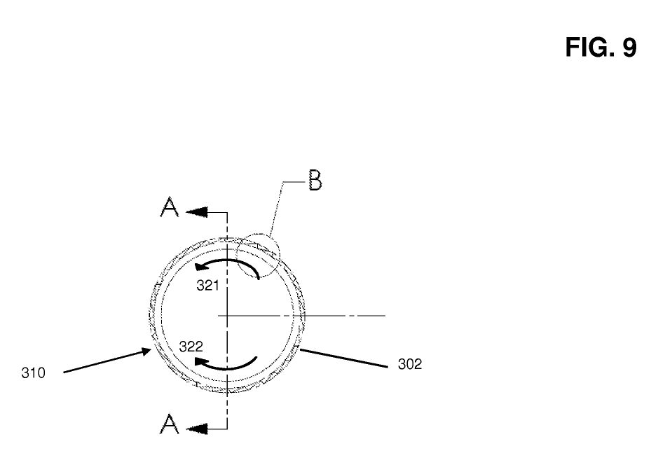

FIG. 10 is a cross-sectional view of the pulley of FIG. 8 and the belt of FIG. 1;

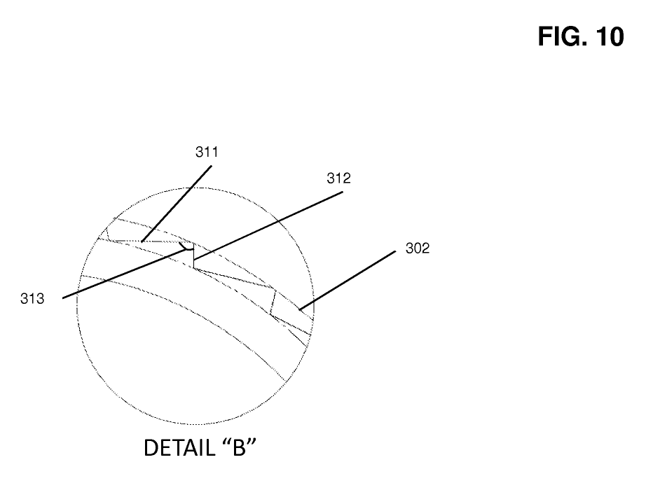

FIG. 11 is a cross-sectional view of the pulley of FIG. 8;

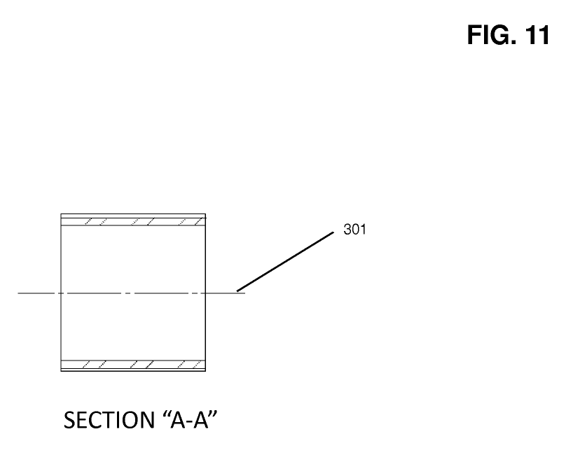

FIG. 12 is a side view of a vehicle representing a preferred embodiment of the present invention;

FIG. 13 is a side view of the belt of FIG. 1;

FIG. 14 is a close-up side view of the belt of FIG. 13;

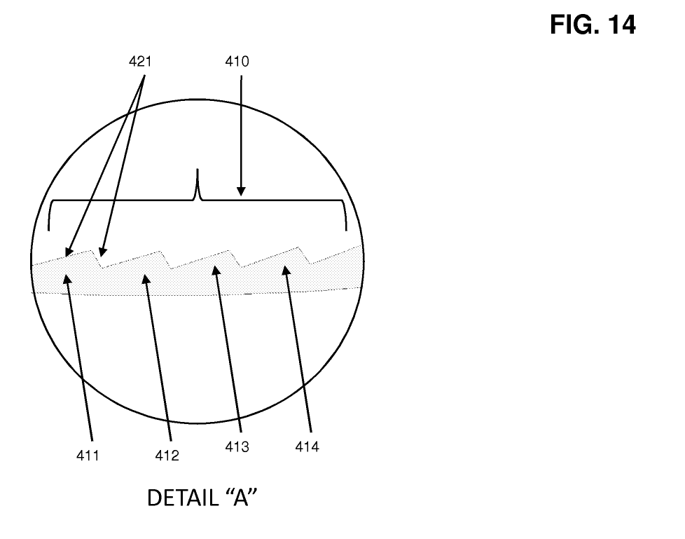

FIG. 15 is a perspective view of the pulley of FIG. 8 with a spoke ring;

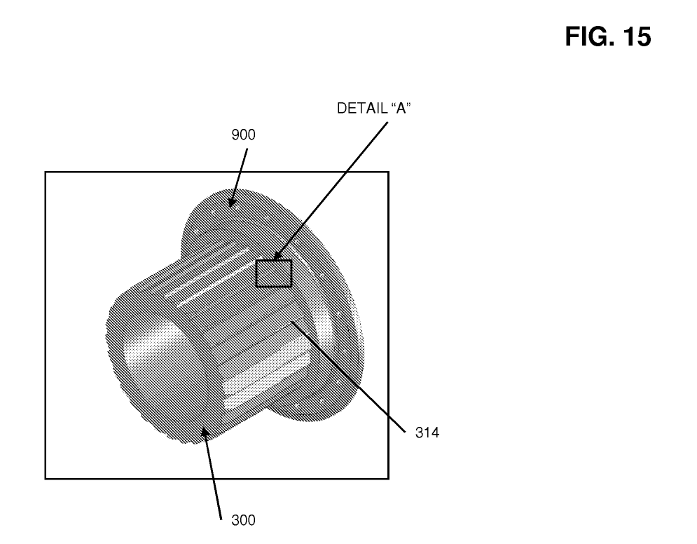

FIG. 16 is a cross-sectional view of the compound fit between the spoke ring (designated “900”) and the driven pulley (designated “300”);

FIG. 17 is a perspective view of the spoke ring shown in FIGS. 15 and 16;

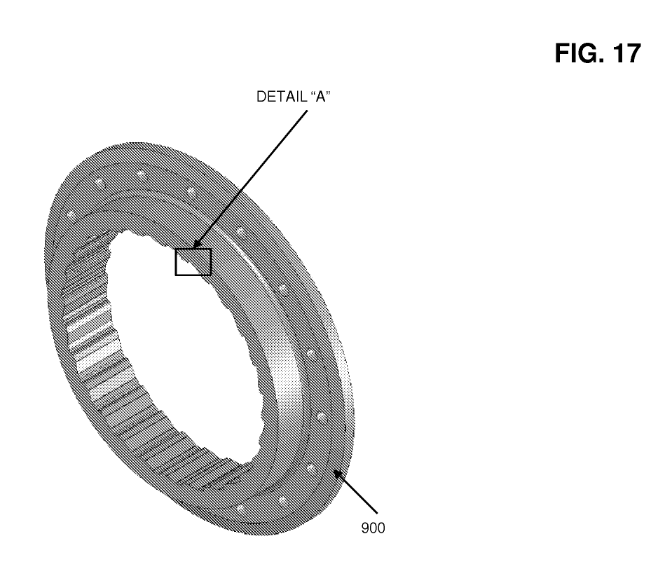

FIG. 18 is a cross-sectional view of a portion of the spoke ring shown in FIG. 17;

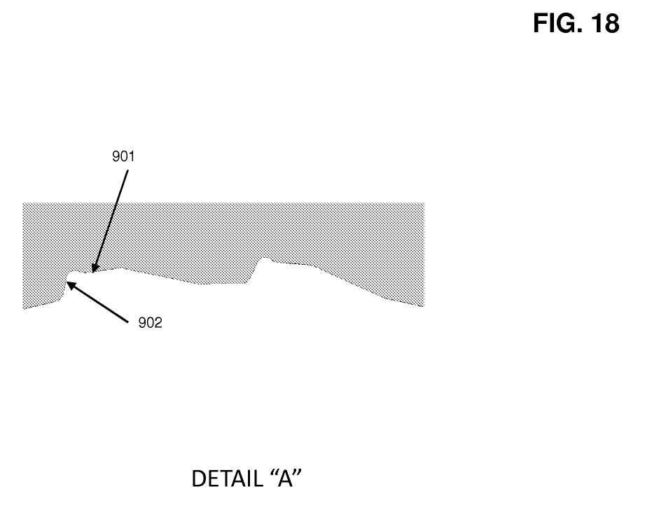

FIG. 19 is a cross-sectional view of the driven pulley and driven hub;

FIG. 20 is a cross-sectional view of a treadle constituting a presenting preferred embodiment of the present invention.

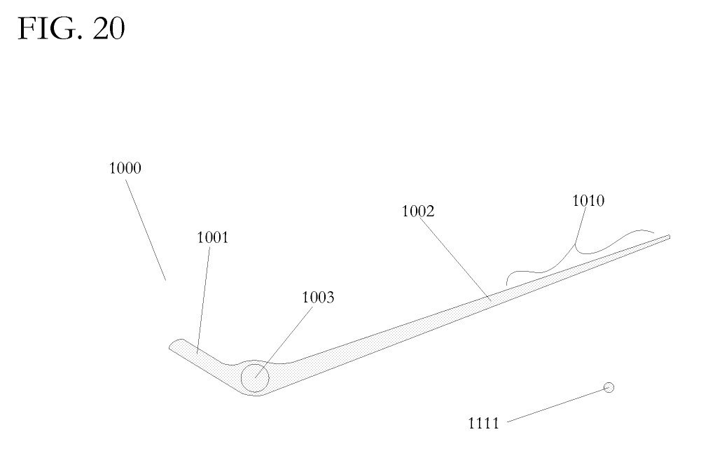

### DETAILED DESCRIPTION

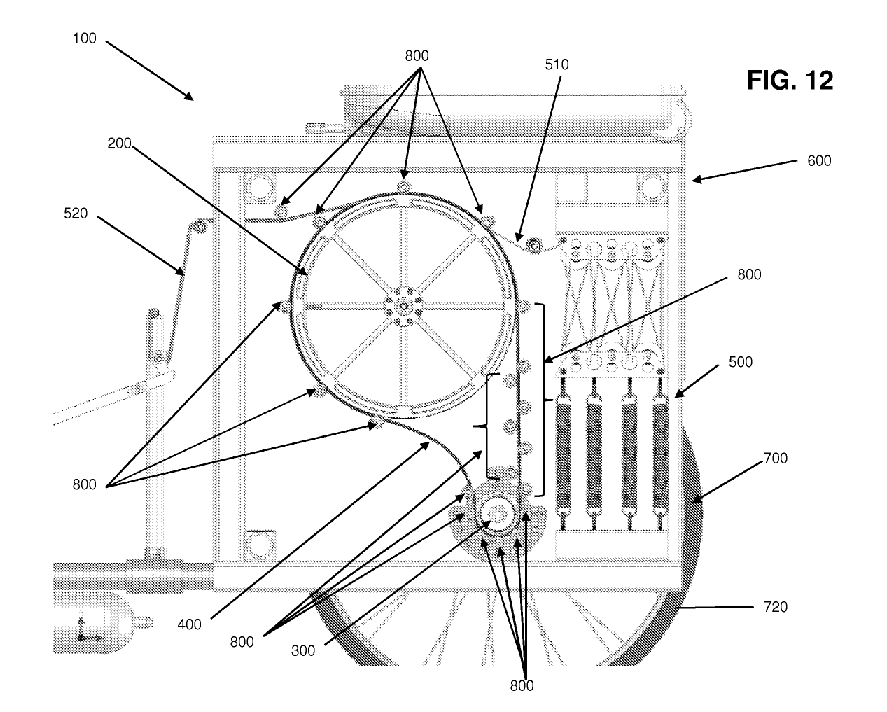

A human-powered vehicle 100 is depicted in FIG. 12. As shown therein, the human-powered vehicle 100 (hereinafter referred to simply as the “vehicle 100”) is provided with a plurality of pulleys 200, 300, referred to as a “first” pulley 200 and a “second” pulley 300 to distinguish one from the other. The vehicle 100 is also provided with a belt 400 that is positioned, at least in part, about the pulleys 200, 300 through use of a plurality of rollers (which are collectively designated “800”). The vehicle includes a retractor 500 that includes a retractor cord 510 and a power cord 520.

The power cord 520 is connected to the first pulley 200 and a treadle (shown in Figure. During a power stroke, the power cord 520 is placed in tension which is released by rotating the first pulley 200 and placing the retractor cord 510 in tension. During a recovery stroke, the tension on the retractor cord 510 is released by rotating the first pulley in an opposing direction, which rewinds the power cord 520 about the first pulley 200 for the next power stroke.

As FIG. 12 illustrates, the pulleys 200, 300, the belt 400, and the retractor 500 are located within a housing 600. As FIG. 12 also illustrates, the vehicle 100 is provided with a wheel 700. In the presently preferred embodiment, the vehicle 100 is provided with a plurality of wheels 710, 720, 730 (a front wheel 710 and a rear wheel 720). Nonetheless, one of skill in the art will understand that a vehicle 100 with three wheels (such as a tri-cycle) and a vehicle with four wheels are within the scope of the present invention.

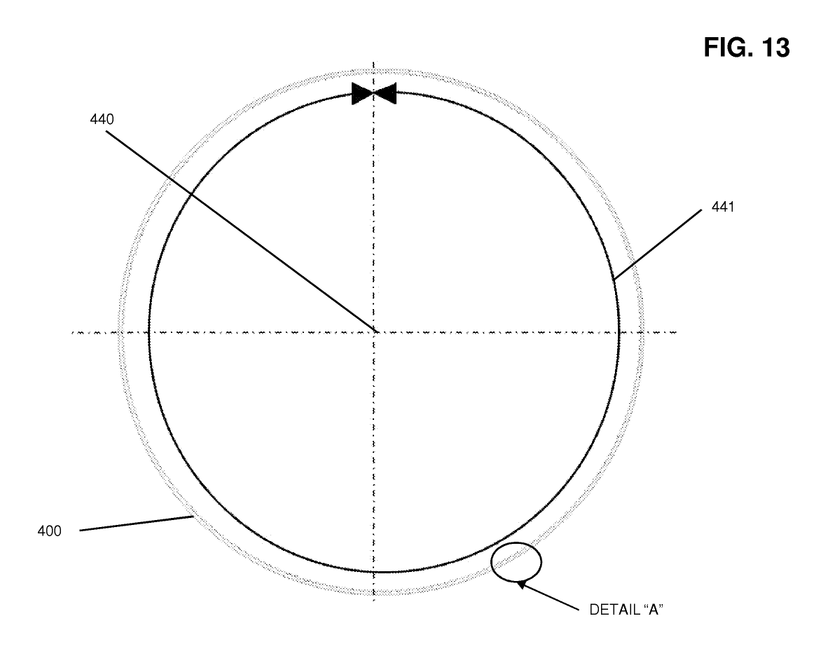

FIG. 13 depicts the belt 400 in an unbent and unflexed state and is hence shown as generally circular with an axis 440 and a circumference 441. The belt 400 is fabricated by being spin cast in a barrel. A reinforcing material, preferably a thread, is helically wound around a mandrel inside the barrel. Because the belt 400 is molded in a predetermined shape, preferably circular, material memory is imparted to the belt 400. Hence, the belt 400 returns to its molded shape, which, in the preferred embodiment, is circular.

As the foregoing indicates, by changing the thickness of the belt 400 or by changing the elastomer to a harder polyurethane, by way of example and not limitation, the material memory of the belt 400 is changed. Thus, the degree to which the belt 400 is biased to disengage a pulley is either increased or decreased. A thicker belt fabricated with a harder polyurethane as an elastomeric material has stronger material memory to return to its molded shape (preferably circular) and hence is provided with a stronger bias to disengagement. Conversely, a thinner belt with a softer polyurethane has weaker material memory for its circular molded shape and hence a weaker bias to disengagement.

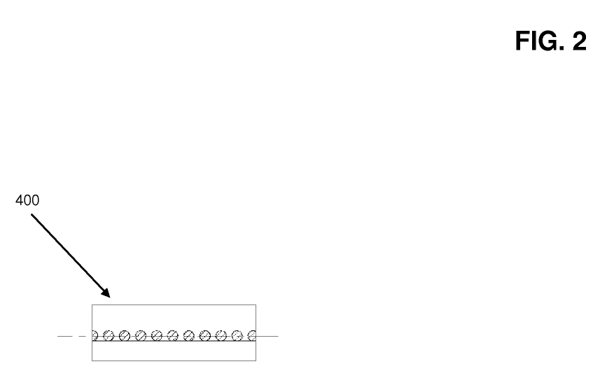

An elastomer is added to the barrel as the barrel is spun. In the presently preferred embodiment, the elastomer is a thermoset plastic; however, in alternative embodiments, a rubber is used. The barrel is spun about its axis to provide the belt 400 with a circular shape with a circumference. Because the belt 400 is fabricated through spin casting, the belt 400 is endless; however, in an alternative embodiment, the belt 400 is extruded in a length, cut, and spliced to form a circular shape. Because the reinforcing material is threaded about the axis of the barrel, the reinforcing material extends about the axis and is generally co-planar with respect to the circumference of the belt 400; in FIG. 2, the reinforcing material is shown as circular fibers extending from the page. Preferably, an aramid fiber is used as the reinforcing material; however, in alternative embodiments, a glass fiber, a carbon fiber, or a polyester fiber are used. Additionally, the foregoing reinforcing fibers may be used together in combination. After spin casting, the elastomer is cured, preferably through the application of heat. After the elastomer is cured, the belt 400 is removed from the mold. The cured elastomer and the reinforcing material provide the belt 400 with a material memory such that, after the belt 400 is deformed from its circular shape, the belt 400 springs back to its original circular shape.

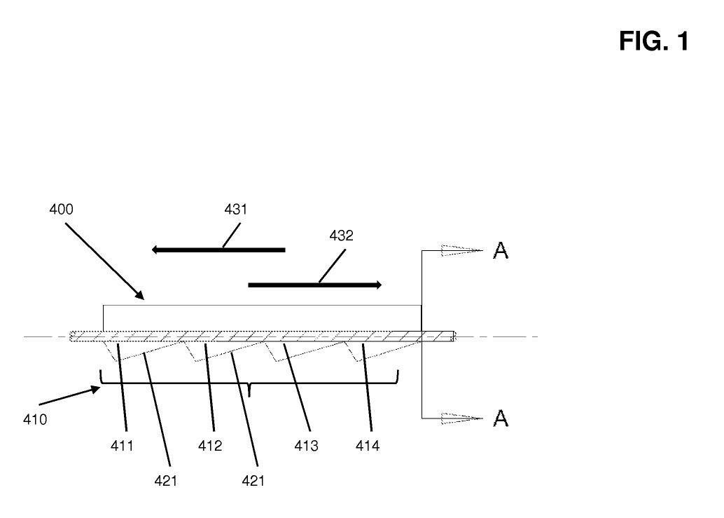

Referring now to FIG. 1, a cross-sectional view of the belt 400 is illustrated therein. The belt 400 is provided with a plurality of teeth (designated collectively as “410”) and is configured to move relative to the pulleys 200, 300 in two directions of relative rotation, a first direction 431 and a second direction 432 (the terms “first” and “second” are used to distinguish one direction from the other). Those of skill in the art will appreciate that the two directions 431, 432 of movement oppose one another.

During a power stroke, the first pulley 200 moves the belt 400 in the first direction 431. The reinforcing material of the belt 400 effectively “pushes” the teeth 410 into engagement with the second pulley 300. During a recover stroke, the first pulley 200 moves the belt 400 in the second direction 432, during which, the material memory of the belt 400 causes the belt 400 to spring back to its original circular shape and thereby wholly disengage the second pulley 300.

Though FIG. 1 illustrates four teeth (which have each been individually designated “411,” “412,” “413,” “414”), it should be understood that the belt 400 is provided with a multitude of teeth 410 with each tooth substantially the same as the others. As FIG. 2 shows, each of the teeth 410 is provided with a tooth profile that is asymmetrical. In cross-section, each of the teeth includes a plurality of sides 421, 422 (referred to herein as a “first tooth side 421” and a “second tooth side 422.” The second tooth side 422 is oriented and shaped to transmit torque while the first tooth side 421 is oriented and shaped to slip. As is shown, the first tooth side 421 is longer than the second tooth side 422. In the preferred embodiment, the first tooth side 421 and the second tooth side 422 form a belt tooth angle 423 that measures between and degrees.

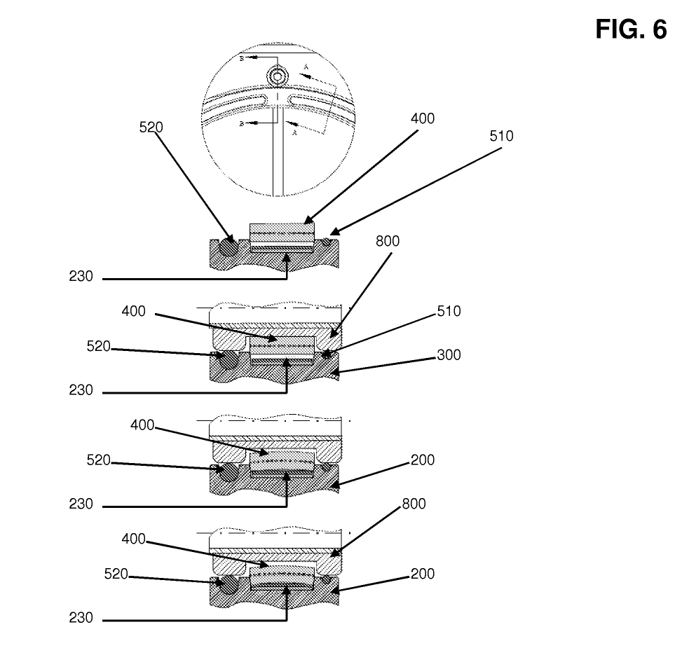

Turning now to FIG. 6, a number of cross-sectional views of the first pulley 200 are included therein. As shown, the first pulley 200 is provided with a first pulley axis 211 and a first pulley circumference 212. The first pulley 200 is also provided with a groove 220 that extends about the axis 211 and along the circumference 212 of the pulley 200. Included within the groove 220 are a plurality of surfaces. As shown in FIG. 6, the groove 220 is provided with a first tapered surface 221 and a second tapered surface 222, a first grooved side 223 and a second grooved side 224, and a base surface 225.

The base surface 225 is oriented to be parallel to the circumference 212 of the pulley 200. The grooved sides 223, 224 extend from the base surface 225 parallel to one another and are oriented to be generally orthogonal relative to the base surface 225 (and hence the circumference 212 of the pulley 200 as well). The grooved sides 223, 224 and the base surface 225 of the groove 220 are dimensioned to accept a band 230 of elastomeric material. As FIG. 6 illustrates, the band 230 fits within the groove 220.

The tapered surfaces 221, 222 extend from the grooved sides 223, 224 at an angle 226 (referred to as a “groove angle 226” in order to distinguish this angle from other angles recited herein). The groove angle 226 measures between (and including) 7.5 and 10 degrees, with the preferred angle 226 measuring between (and including) 9 and 10 degrees. The tapered surfaces 221, 222 cooperate with the belt 400. When the belt 400 and the first pulley 200 are in contact, the tension of the belt 400 and the tapered surfaces 221, 222 cause the belt 400 to crown and thereby contact the band 230 of elastomeric material. Thus, the degree to which the belt 400 and the pulley 200 are engaged is controlled. By providing the tapered surfaces 221, 222 with an angle 226 that is steeper, the belt 400 crowns more thereby putting the teeth 410 into greater contact with the band 230 of elastomeric material. Conversely, by providing the tapered surfaces 221, 222 with an angle 226 that is shallower, the belt 400 crowns less, and hence, the teeth 410 of the belt 400 are less in contact with the band 230. With less contact, the belt 400 tends to slip, rather than engage, the first pulley 200. Because contact between the teeth 410 of the belt 400 and the band 230 of elastomeric material is controlled, the degree of engagement between the belt 400 and the first pulley 200 is also controlled. Consequently, the first pulley 200 is configured to achieve a controlled slip.

Band 230 is made of a harder material, the teeth 410 of the belt 400 are less able to bite into the band 230, and hence, less normal pressure is exerted on the tapered surfaces 221, 222. Thus, slip of the belt 400 on the surfaces 221, 222 is controlled and optimized for the anticipated maximum torque applied to the pulley 200

By controlling slip of the belt 400, different sets of teeth 410 engage the pulleys 200, 300. Wear of the belt 400 is distributed. So too, wear of the pulleys 200, 300 is also distributed.

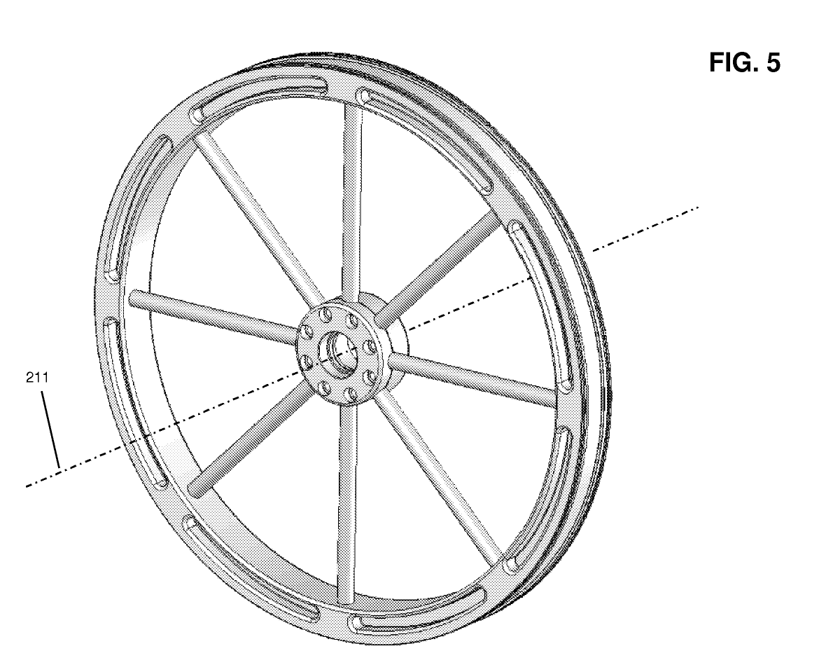

Referring now to FIG. 5, the pulley 300 is shown. In the preferred embodiment, the pulley 300 is fabricated from powdered metal; however, in alternative embodiments, the pulley 300 is fabricated from a phenolic. In yet another alternative embodiment, the pulley 300 is fabricated from an epoxy resin that includes fiber reinforcement.

The pulley 300 is generally cylindrical in shape and hence includes an axis 301 and circumference 302. A plurality of pulley teeth 310 radiate from the circumference 302 of the pulley 300. The pulley teeth 310 are shaped to cooperate with the teeth 410 of the belt 400. As FIG. 5 illustrates, each of the pulley teeth 310 is provided with a first tooth side 311 and a second tooth side 312 (referred to as a “first pulley tooth side” and a “second pulley tooth side” in order to distinguish sides of the pulley teeth 310 from the sides 421, 422 of the teeth 410 on belt 400.) The sides 311, 312 of the pulley teeth 310 form an angle 313 (which shall hereinafter be referred to as a “pulley angle 313” in order to distinguish the angle 313 of the pulley teeth 310 from the angle 423 of the belt teeth 410).

The pulley angle 313 according to the diameter of the pulley, with the pulley angle 313 of the preferred embodiment measuring 90. One of the sides 311, 312 of the pulley teeth 310 is oriented and shaped to engage the teeth 410 of the belt 400 (and thereby transmit torque to the rear wheel 720) while another side of the pulley teeth 310 is oriented and shaped so that the teeth 410 of the belt 400 slip over the pulley 300 (and thereby transmit no torque to the rear wheel 720). As FIG. 5 illustrates, the first pulley tooth side 311 is longer than the second pulley tooth side 312.

As shown in FIG. 2, each of the pulley teeth 310 is provided with a first side 311 and a second side 312. The second side 312 is oriented and shaped to transmit torque while the first pulley tooth side 311 is oriented and shaped to slip. Thus, when the teeth 410 of the belt 400 are moved over the teeth 310 of the pulley 300, the belt 400 slips in one direction but engages and transmits torque in the other direction.

During a power stroke, the first pulley 200 moves the belt 400 in the first direction 431 and the reinforcing material of the belt 400 “pushes” the teeth 410 of the belt 400 into contact with the teeth 310 of the second pulley 300. Though the teeth 410 of the belt 400 are moved in the first direction 431, the teeth 310 of the second pulley 300 may be rotating faster than the teeth 410 of the belt 400 (e.g. while traveling down a steep incline). In such a case, a first tooth side 421 on the belt 400 contacts a first tooth side 311 on the second pulley 300 (rather than the second tooth side 422 on the belt 400 contacting the second tooth side 312 on the pulley). Because the first tooth side 311 of the second pulley 300 and the first tooth side 421 of the belt 400 are both oriented and shaped to slip, the teeth of belt 400 slip over the second pulley 300.

A controlled slip is also created between the belt 400 and the first pulley 200. The band 230 within the first pulley 200 is fabricated to control the engagement between the belt 400 and the first pulley 200. Like the belt 400, the band 230 is fabricated through spin casting. By adding softer elastomeric material during the spin casting the band 230 is rendered less prone to slipping. Because the band 230 is made of a softer elastomeric material, the teeth 410 of the belt 400 are more able to bite into the band 230, and hence, greater control is achieved between the belt 400 and the band 230 (and by extension, the pulley 200 itself). Conversely, by adding harder elastomeric material during the spin casting of the band 230, the band 230 is rendered more prone to slipping. Thus, the band 230 of the presently preferred embodiment creates a controlled slip of the belt 400 relative to the pulleys 200, 300.

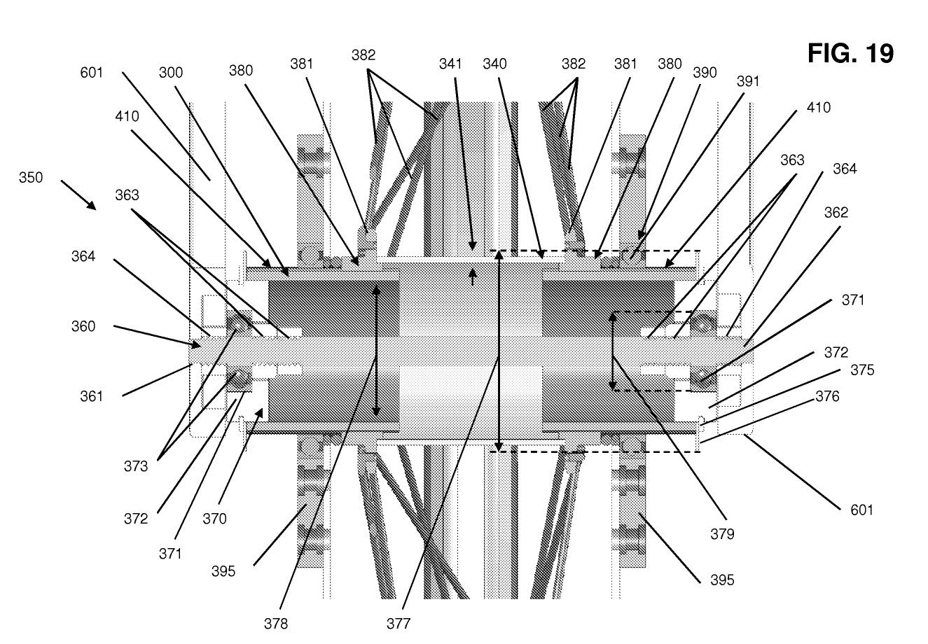

Referring now to FIG. 19, a hub 350 is shown. As illustrated, the hub 350 is provided with an axle 360, a bearing assembly 370, and a spoke ring 380. In the preferred embodiment, the axle 360 is a shaft that includes an aluminum and provided with a plurality of threads 363. As FIG. 19 shows, the axle 360 is generally cylindrical in shape and provided with a first end 361 and a second end 362. Each of the ends 361, 362 of the preferred embodiment is threaded (though, in an alternative embodiment, a threaded bolt is used). A nut 364 is used to secure the hub 350 (and hence the wheel 200) to the frame 601 of the vehicle 100.

As noted above, the hub 350 is also provided with a bearing assembly 370. Included therein is a bearing 371, also referred to as an “inboard bearing,” and a bearing block 372. As FIG. 19 illustrates, the inboard bearing 371 includes a plurality of curved members 373, which in the preferred embodiment are stainless steel balls In an alternative embodiment, the curved members are generally cylindrical in shape. As FIG. 19 also illustrates, the bearing block 372 is a machined plastic with an inner diameter 374 that is dimensioned according to the outer diameter of the inboard bearing 371.

The bearing block 372 is also provided with a shoulder 375 and a flange 376. As FIG. 19 illustrates, the flange 376 is provided with a flange block diameter 377 which is dimensioned to be larger than the outer diameter 325 of the drive pulley 300. The shoulder 375, in turn, is provided with a shoulder diameter 378. The shoulder diameter 378 is dimensioned according to the inner diameter 326 of the drive pulley 300. Thus, the shoulder 375 of the bearing block 372 supports an end of the drive pulley 300. Furthermore, because the flange 376 extends beyond the outer diameter 327 of the drive pulley 300, the flange 326 acts as a guide for the belt 400.

The hub 350 is also provided with a spacer 340. In the preferred embodiment, the spacer 340 is fabricated from a plastic that includes a wall 341. The wall 341 of the spacer 340 is provided with a wall thickness of 1/16 of an inch. However, in an alternative embodiment, the spacer 340 (and hence the wall 341 of the spacer 340) is fabricated from a metal, such as a steel, and, in such an embodiment, is provided with a wall 341 with a thickness measuring 1/32 of an inch. Therefore, as the foregoing illustrates, the wall 341 of the spacer 340 is provided with a thickness that ranges between 1/32 to 1/16 of an inch.

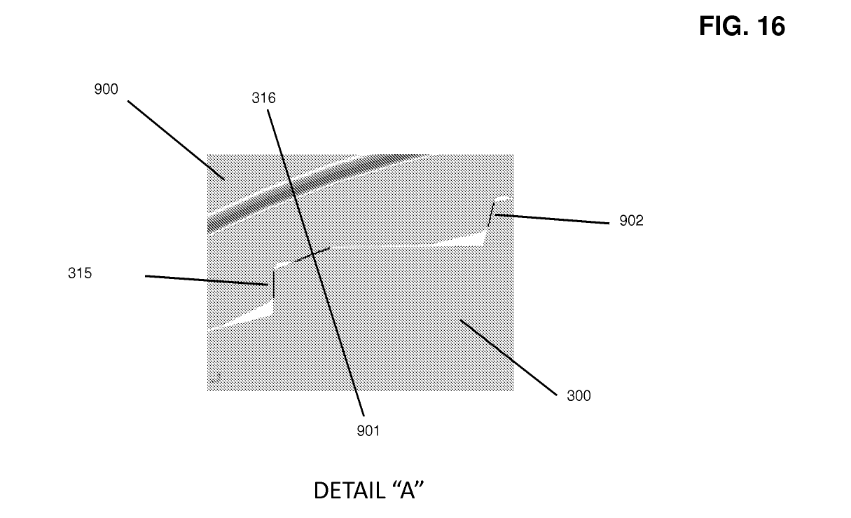

The spacer 340 abuts the spoke ring 380. As FIG. 19 illustrates, the spoke ring 380 is provided with a spoke flange 381, which includes a plurality of holes for a plurality of spokes 382. The spoke ring 380 rides on the pulley 300 via a compound fit. This compound fit is achieved at least in part through the frictional engagement of a surface on the spoke ring 380 and a surface on the pulley 300. More specifically, the teeth 410 are provided with a step 314. As illustrated in FIG. 16, the step 314 includes a generally cylindrical surface 316 and a radial surface 315 (which extends from the pulley 300 in a direction that is generally radial).

As noted above and illustrated in FIG. 12, the vehicle 100 is provided with a plurality of rollers 800 that are positioned radially (at least in part) about the hub 350. Though the rollers 800 are arranged about the hub 350, the rollers 800 remain stationary relative to the hub 350 and are attached to a roller fixture 395. As a result, the hub 350 is provided with a bearing 390 that rides on the outer surface of the pulley 300 (hereinafter the bearing 390 shall be referred to as the “outboard bearing” to distinguish it from the “inboard bearing 371”). Much like the inboard bearing 371, the

[symbol]

What is claimed is:

1. A pulley, comprising:
a) a hub shell provided with a first flange and a second flange;
b) a composite axle that is provided with a plurality of stops, a first end, and a second end;
c) a first end cap and a second end cap;
d) the first end cap is secured to the first end of the composite axle; and
e) the second end cap is secured to the second end of the composite axle.
